(19) United States
(12) Patent Application Publication
(10) Pub. No.: US 2024/0263414 A1
(43) Pub. Date: Aug. 8, 2024

(54) OCEAN CIRCULATION SYSTEMS AND METHODS

(71) Applicant: Hans Gude GUDESEN, Gamle Fredrikstad (NO)

(72) Inventor: Hans Gude GUDESEN, Gamle Fredrikstad (NO)

(21) Appl. No.: 18/564,061

(22) PCT Filed: May 25, 2022
(86) PCT No.: PCT/NO2022/050117

§ 371 Date: Nov. 24, 2023

(30) Foreign Application Priority Data
May 27, 2021 (CN) 20210677

(51) Int. Cl. E02B 1/00; A01K 61/60

(52) U.S. Cl. CPC E02B 1/003; A01K 61/60

(57) ABSTRACT

A system for transport of water between different depths in a body of water is disclosed. The system comprises a sequence of modules constituting a channel, impeller means arranged related to at least one module for contributing to the transport of water, and controlling and guiding means arranged related to the at least one module for controlling and guiding flow of water into or out of the channel. A method corresponding to the system is disclosed. Use of the system and the method related to fanning of aquatic organisms in a bioreactor is also disclosed.

### FIELD OF THE INVENTION

The present invention generally relates to systems and methods for controlling and exploiting localized vertical transport of water within large bodies of water.

### BACKGROUND OF THE INVENTION

The world's oceans have played a key role in the evolution of atmospheric CO₂ by absorbing a significant fraction of CO₂ emitted into the atmosphere by human activities. During recent years, the global ocean has absorbed 2.6 10⁹ tons of carbon annually, representing nearly 30% of anthropogenic emissions over this period. Absorption of CO₂ at the ocean surface initiates a series of processes that ultimately result in part of the carbon from absorbed CO₂ being transported from the surface to deep water layers and seafloor sediments. These processes, termed the “carbon pump” here, may be categorized as inorganic or biological. The former, the inorganic gas-exchange carbon pump which includes dissolved inorganic carbon (DIC) in the form of dissolved CO₂/carbonic acid/bicarbonate/carbonate, operates in parallel with the latter, the biological pump which in turn includes particulate organic carbon (POC) and dissolved organic carbon (DOC). Coccolithophores are calcifying phytoplankton that make up a major part of the particulate organic carbon (POC), and are estimated to account for 50% of the total vertical CaCO₃ flux in open ocean waters, with foraminifera shells responsible for most of the rest. The aggregated and larger size fractions of the particulate organic carbon (POC) exhibit significant settling in the water, whereas the smaller size fractions and dissolved organic carbon (DOC) tends to remain floating.

It has been estimated (Ref., e.g.: S. Honjo et al. “Understanding the role of the biologicalpump in the global carbon cycle”, Oceanography vol. 27, No. 3, pp. 10-16, 2014) that primary production by photosynthetic fixation of inorganic carbon into phytoplankton biomass is responsible for oceanic uptake of an estimated 3 to 4 petamoles carbon per year (1 petamole C=12 10⁹ tons C). This vastly exceeds the yearly build-up of carbon (CO₂—C) in the atmospheric reservoir which has been estimated at 0.28 petamoles carbon per year. Thus, the biological pump could in principle solve the problem of atmospheric build-up of CO₂ by capturing the CO₂ in the phytoplanctic domain near the ocean surface and allowing the POC to sediment to the deep ocean and sequester there. However, it has been estimated (Ref., e.g.: S. Honjo et al., Op. Cit.) that only 0.04 petamoles C per year sediments as POC to the deep ocean, whereas most of POC and DOC remain in the upper water layers where they are metabolized by plankton and bacteria, creating CO₂ which is returned to the atmosphere. The major reason is stratification in the ocean which presents barriers to vertical transport:

The pycnocline is the layer within a body of water where the density gradient is greatest. It is generally linked to the thermocline and plays a central role for regulating the vertical transport of marine living organisms and nutrients between different depths in the water. In a simplified scenario, the pycnocline hinders transport of essential nutrients from the deeper water layers to the photosynthetically active algae in the uppermost water layers, and hinders transport of algae and detritus from dead algal and planctonic matter into the deep ocean below the pycnocline.

Processes that create shear-produced turbulence, e.g. wind, breaking waves, tides, etc. occur naturally in the oceans and cause vertical mixing between upper and lower layers, but not with a regularity and on a scale where the true potential of the biological pump for carbon capture from the atmosphere can be realized. There appears at present to exist a clear need for human intervention on a global scale to assist in boosting the biological pump in the oceans, paralleling the present efforts at scaling back anthropogenic CO₂ emissions into the atmosphere.

### SUMMARY OF THE INVENTION

A first aspect of the invention is a system for transport of water between different depths in a body of water, where the system comprises a sequence of modules constituting a channel with an upper and a lower channel end and a channel length, with at least one of the modules being a technical module arranged at the upper and/or lower channel ends, for allowing water to enter at least one channel end, being transported through the channel, and exiting at the other channel end, impeller means arranged related to the at least one technical module for contributing to the transport of water, and controlling and guiding means arranged related to the at least one technical module for controlling and guiding flow of water into or out of the channel.

Optionally the system is arranged for controllable up- and/or downwelling, where up- and downwelling respectively correspond to effecting transport of upwelled water from the lower to the upper channel end, and of downwelled water from the upper to the lower channel end.

Optionally, the channel is an enclosed channel comprising a wall arranged for confining water within a cross section of the channel limited by the wall.

Optionally, the channel is an open channel where the impeller means are arranged for generating a flow of water within a cross section of the channel limited by dynamic forces.

Optionally, part of the channel length is an enclosed channel comprising a wall arranged for confining water within a cross section of the channel limited by the wall, and part of the channel length is an open channel where the impeller means are arranged for generating a flow of water within a cross section of the channel limited by dynamic forces.

Optionally, at least one impeller is arranged related to the channel and located between the upper and lower channel ends, and further optionally the impeller means are arranged for controllably contributing to transport of water into the channel, and to pushing it through the channel. Optionally, the impeller means are arranged for controllably contributing to transport of water out of the channel, and pulling it through the channel.

Optionally, the sequence of modules comprises at least one extension module arranged between the channel ends, where the at least one extension module comprises at least one of the following: i) impeller means arranged to contribute to the transport of water through the channel, ii) diagnostic equipment arranged for measuring characteristics of the water in the channel, and iii) length extension of the channel.

Optionally, the impeller means comprises at least one motor driven impeller arranged to i) propel water inside the channel and/or ii) set up vortex motion, and further optionally, the at least one motor driven impeller is of the Lily type.

Optionally, the system further comprises a suspension system arranged to connect at least two neighboring modules, and physically contribute to control relative position of the connected modules.

Optionally, the system comprises a topside platform comprising buoyancy elements, a work deck, operational equipment and suspension means for enclosed or open channels.

Optionally, the system comprises control means arranged for controlling direction of the water flow in the channel according to a predetermined time schedule or according to input data from system-associated sensors measuring physical or chemical environmental factors, and further optionally, the physical or chemical environmental factors include one or more of the following: Ambient light level above or below water surface, concentration of dissolved CO₂ or O₂ at selected points in the water flow in the system, pH and temperature at selected points in the water flow in the system, turbidity.

Optionally, where the body of water has a photic zone and a thermocline, the channel is arranged with the upper channel end in the photic zone and the lower channel end below the thermocline, and the controlled direction of the water flow is from the photic zone to below the thermocline in a downwelling period of a 24-hour period, and from below the thermocline to the photic zone in an upwelling period of the 24-hour period. Further optionally, the upwelling period takes place during hours of daylight (“daytime”) and the downwelling takes place during hours of darkness (“nighttime”).

Optionally, the system comprises generator means arranged for generating gas-filled bubbles and/or nanocavities, and seeding means arranged for seeding water in the channel with the gas-filled bubbles and/or nanocavities. Further optionally, the seeding means are arranged for seeding upwelled water and the system is arranged for distributing upwelled water into surface layers in the water surrounding the system or at remote locations, where the temperature of the upwelled water is lower than the temperature of the water where it is distributed.

Optionally, the system comprises means for introducing water carrying dissolved inorganic carbon (DIC laden water) into the channel for downwelling. Further optionally, the means for introducing DIC laden water comprises a separator stage arranged for receiving flue gases and water, removing N₂ and O₂ from the flue gas and dissolving CO₂ in the water. Further optionally, the system comprises means for processing arranged to control and adjust physical and chemical parameters of the DIC laden water. Further optionally, the system comprises means for sequestration of downwelled DIC laden water, by one or more of the following: Dispersion into deep sea water volumes, temporary storage in flexible containers in the sea, exposing seafloor minerals to react with DIC laden water, filling void volumes associated with abandoned subsea oil wells and aquifers, using DIC laden water as forcing fluid in EOR (Enhanced Oil Recovery). Further optionally, the system comprises at least one of i) means for admixing air with the flue gas before being received by the separator stage, and ii) means for diluting the DIC laden water with fresh water.

Optionally, the system is adapted to function as a bioreactor for farming of aquatic organisms, and comprises containment and exposure means for containment of the aquatic organisms within the channel and for exposing them to water flowing through the channel. Optionally, the containment and exposure means comprise substrates with surfaces, adapted to serve as habitats for sessile organisms, the substrates being arranged in the channel and exposed to water flowing in the channel. Optionally, the substrates comprise at least one of the following: ropes, flexible sheets, plates, and bands. Optionally, the containment and exposure means are comprises at least one of the following: mesh bags and cages. Optionally, the aquatic organisms comprise at least one of the following: autotrophic or heterotrophic biomass, algae, tunicates, mussels, crustaceans, fish, and benthic organisms. Optionally, the system comprises particle trap means arranged for collecting particulate materials ejected by the aquatic organisms. Further optionally, the system comprises means for controlling the flow of water through the bioreactor. Further optionally, the system comprises an intake manifold arranged at one channel end and adapted to lead water in a natural water flow in the body of water into the channel. Further optionally, the system comprises means for upstream seeding of the natural water flow in the body of water being led into the channel.

Optionally, the system is adapted to function as a bioreactor, where the system is arranged with the lower channel end at a depth below the thermocline of the body of water for drawing water into and upwelling it through the channel, and where the system further comprises a conditioning stage arranged for receiving and conditioning the upwelled water, a farming volume arranged for receiving the conditioned water and for farming of cold-water fish or other organisms, and expelling means arranged to expel spent water from the farming volume into the body of water.

Optionally, the conditioning stage is arranged for performing one or more of the following tasks: controlling the oxygen content and salinity of the upwelled water, adding nutrients and medicines to the upwelled water, and admixing surface water to the upwelled water for maintaining optimal water temperature, where the surface water is warmer than the upwelled water.

A further aspect of the invention is a method for transport of water between different depths in a body of water, where the method comprises controlling and guiding a flow of water from the body of water into and/or out of a channel constituted of a sequence of modules with at least one of the modules being a technical module arranged at the upper and/or lower channel ends; and contributing to transporting water through the channel by impeller means arranged related to the at least one technical module.

Optionally, the method comprises controllable up- and/or downwelling, where up- and downwelling respectively correspond to effecting transport of upwelled water from the lower to the upper channel end, and of downwelled water from the upper to the lower channel end.

Optionally, the method comprises controlling direction of the water flow in the channel according to a predetermined time schedule or based on input data from system-associated sensors measuring physical or chemical environmental factors. Optionally, where the body of water has a photic zone and a thermocline, the method comprises arranging the channel with the upper channel end in the photic zone and the lower channel end below the thermocline, and controlling direction of the water flow from the photic zone to below the thermocline in a downwelling period of a 24-hour period, and from below the thermocline to the photic zone in an upwelling period of the 24-hour period. Further optionally, the upwelling period takes place during hours of daylight (“daytime”) and the downwelling takes place during hours of darkness (“nighttime”). Further optionally, the method comprises generating gas-filled bubbles and/or nanocavities and seeding water in the channel with the gas-filled bubbles and/or nanocavities.

Optionally the method comprises upwelling water, seeding the upwelled water with gas-filled bubbles and/or nanocavities, and distributing the upwelled water into surface layers in the water surrounding the system or at remote locations where the temperature of the upwelled water is lower than the temperature of the water where it is distributed.

Optionally, the gas in the gas-filled bubbles and/or cavities include one or more of the following: Ambient air, CO₂, O₂, flue gas, and the seeding comprises seeding water from surface layers, and the method further comprises downwelling the seeded water. Further optionally, the method comprises at least partially removing other gases than CO₂ before generating the bubbles and/or nanocavities.

Optionally, the method comprises admixing materials into water in the channel.

Optionally, the method comprises controlling and adjusting physical and chemical parameters of the seeded water before entering the channel, and downwelling the seeded water.

Optionally, the method comprises introducing water carrying dissolved inorganic carbon (DIC laden water) into the channel, and downwelling the DIC laden water. Further optionally, the introducing DIC laden water comprises receiving flue gases and water, removing N₂ and O₂ from the flue gas and dissolving CO₂ in the water in a separator stage. Further optionally, the method comprises prior to the introducing DIC laden water, controlling and adjusting physical and chemical parameters of the DIC laden water.

Optionally, the method comprises sequestrating the downwelled DIC laden water by one or more of the following: dispersion into deep sea water volumes, temporary storage in flexible containers in the sea, exposing seafloor minerals to react with DIC laden water, filling void volumes associated with abandoned subsea oil wells and aquifers, using DIC laden water as forcing fluid in EOR (enhanced oil recovery).

Optionally, the method comprises at least one of i) admixing air with the flue gas before being received by the separator stage, and ii) diluting the DIC laden water with fresh water.

Optionally, where the method is used related to farming of aquatic organisms in a bioreactor, the method comprises containing the aquatic organisms within the channel, and exposing the aquatic organisms to water flowing through the channel. Further optionally, the method further comprises at least one of the following steps:
collecting particulate materials ejected by the aquatic organisms by particle trap means:
leading water in a natural water flow in the body of water into the channel via an intake manifold arranged at one channel end; and
seeding of the natural water flow in the body of water being led into the channel.

Optionally, the method upwelling water through the channel from a depth below the thermocline, conditioning the upwelled water in a conditioning stage, transporting the conditioned water into an enclosed volume of the bioreactor for farming of cold-water fish or other organisms, and expelling spent water from the enclosed volume to the surrounding water volume. Further optionally, the conditioning comprises one of more of the following steps: controlling oxygen content and salinity of the (upwelled) water, adding nutrients and medicines to the (upwelled) water, and admixing surface water to the upwelled water for maintaining optimal water temperature, where the surface water is warmer than the upwelled water.

### DESCRIPTION OF THE FIGURES

Embodiments of the present invention will now be described, by way of example only, with reference to the following figures, wherein:

FIG. 1 shows enclosed transport channel, principle.

FIG. 2 shows open transport channel, principle.

FIG. 3 shows Lily impeller.

FIG. 4a-b shows diel cycling of upwelling and downwelling.

FIG. 5a-b shows vertical nanocavity transport.

FIG. 6 shows CO₂ capture and downwelling.

FIG. 7 shows gas separation principle.

FIG. 8 shows bioreactor.

FIG. 9 shows cold water upwelling.

### LIST OF REFERENCE NUMBERS IN THE FIGURES

The following reference numbers refer to the drawings:

### Number Designation

1 Topside platform
2 Upper technical module
3 Enclosed channel
4A-N Technical extension modules
5 Lower technical module
6 Topside platform
7 Upper technical module
8 Suspension system
9A-M Cascade modules
10 Lower technical module
11 Impeller
12 Stream of water
13 Thermocline
14 Stream of water
15 Photic zone
16 Water with biomass
17 Water expelled at deep location
18 Tube
19 Nanocavity generator
20 Air
21 Distributed nanocavity laden water
22 Nanocavity generator
23 Air
24 Water
25 Tube
26 Nanocavity gas
27 Flue gas
28 Separation stage
29 Gas ejection
30 Column
31 Tube
32 Tube
33 Flue gas
34 Bubbles
35 Diffuser
36 Surface
37 Void
38 Atmosphere
39 Process unit
40 Tube
41 Fresh air
42 Fresh water
43 Substrates
44 Particle trap
45 Particulate nutrients
46 Intake manifold
47 Natural water flow
48 Fertilizer spreading location
49 Conditioning stage
50 Enclosed volume
51 Spent water

### DESCRIPTION OF PREFERRED EMBODIMENTS OF THE INVENTION

The present invention teaches how to create systems constituting high capacity vertical transport channels for upwelling or downwelling of water in large bodies of water. The systems can play an important role in mitigating the build-up of CO₂ in the atmosphere by assisting the biological pump in the global carbon cycle, and can provide infrastructures for a range of unique applications where chemical and biological processes take place in large volumes of water.

Before embarking on detailed descriptions of certain preferred applications, two generic classes of upwelling and downwelling infrastructures shall be described, termed “enclosed channel circulation systems” and “open channel circulation systems”. As shall be described, both types of systems can incorporate installations that enable the systems to effectively become reactors for chemical or biological processes, in which cases individual systems may be termed “reactor modules” below.

In enclosed channel circulation systems a stream of water is created within an essentially vertically oriented confining wall, typically of tubular shape. The flow direction may be either upwards (upwelling) or downwards (downwelling), and water enters and exits the system through openings at the top and bottom of the confining wall.

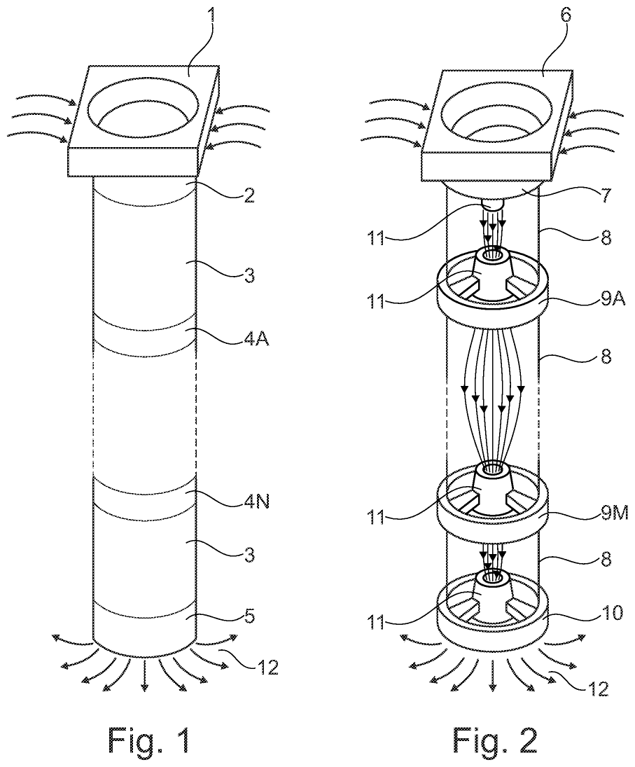

FIG. 1 shows the major elements comprising an enclosed channel ocean circulation system, operating in the downwelling mode. They include:
A topside platform (1)
An upper technical module (2)
An enclosed channel (3)
Technical extension modules (4A-N)
A lower technical module (5).

Where:
The topside platform (1) comprises buoyancy elements, a work deck, operational equipment (electrical power connections, pumps, crane, etc.), moorings, beacons and personnel access features.
The upper technical module (2) links the topside platform (1) to the enclosed channel (3) and comprises a control and guide system for downwelling water entering the closed channel or upwelling water exiting the closed channel. In the former case, water is drawn from a defined depth range near the water surface and is guided into the enclosed channel before being transported downwards and expelled from the enclosed channel at depth. In the latter case water is drawn into the enclosed channel at depth and is transported up to the surface where it is dispersed by the control and guide system in the upper module. In either case, the upper technical module may be equipped with one or more motor-driven impellers that propel the water inside the enclosed channel.
The enclosed channel (3) extends from the water surface and to the lower end of the system, forming a wall which confines the water inside the channel. The wall shall typically have a cylindrical tubular shape and may consist of linked, modular segments.
Depending on circumstances, a number of technical extension modules (4A-N) may be interspersed along the length of the enclosed channel, with different types of functionalities, e.g.: carrying diagnostic equipment to perform qualitative and/or quantitative measurements of mass transport in the enclosed channel, or carrying impellers to assist in boosting the water flow.
The lower technical module (5) terminates the lower end of the system, and is equipped with means for guiding water out of or into the enclosed channel (3) and controlling the exchange of water with the local environment. In FIG. 1, a stream of water (12) is shown flowing away from the exit of the technical module (5). In analogy with the upper technical module (2) and the technical extension modules (4A-N), the lower technical module may be equipped with one or more motor-driven impellers that propel the water inside the enclosed channel (3).

In open channel circulation systems a jet of water is created traveling essentially in a vertical direction through a body of water, with return flow of water in the volume surrounding the jet. The jet is confined within a limited cross section by dynamic forces and not by a surrounding wall. The flow direction in the jet may be either upwards (upwelling) or downwards (downwelling).

FIG. 2 shows the major elements comprising an open channel ocean circulation system, operating in the downwelling mode. They include:
A topside platform (6)
An upper technical module (7)
Suspension system (8)
Cascade modules (9A-M)
A lower technical module (10).

Where:
The topside platform (6) comprises buoyancy elements, a work deck, operational equipment (electrical power connections, pumps, crane, etc.), moorings, beacons and personnel access features.
The upper technical module (7) is attached to the topside platform (6) and comprises a control and guide system for downwelling water entering the top of the open channel or upwelling water exiting from the top of the open channel. In the former case, water is drawn from a defined depth range near the water surface and is guided into the open channel before being transported downwards and expelled from the open channel at depth. In the latter case water is drawn into the open channel at depth and is transported up to the surface where it is dispersed by the control and guide system in the upper technical module. In either case, the upper technical module may be equipped with one or more motor-driven impellers that propel the water inside the open channel.
The suspension system (8) extends from the topside platform (6) to the lower technical module (10). It may take many forms and is shown as a set of suspension cables (8) in FIG. 2. Its main purpose is to position the cascade modules (9A-M) and lower technical module (10) and thus define the trajectory of the open channel.
The lower technical module (10) terminates the lower end of the system, and is equipped with means for guiding water out of or into the open channel and controlling the exchange of water with the local environment. In analogy with the upper technical module, the lower technical module may be equipped with one or more motor-driven impellers (11).

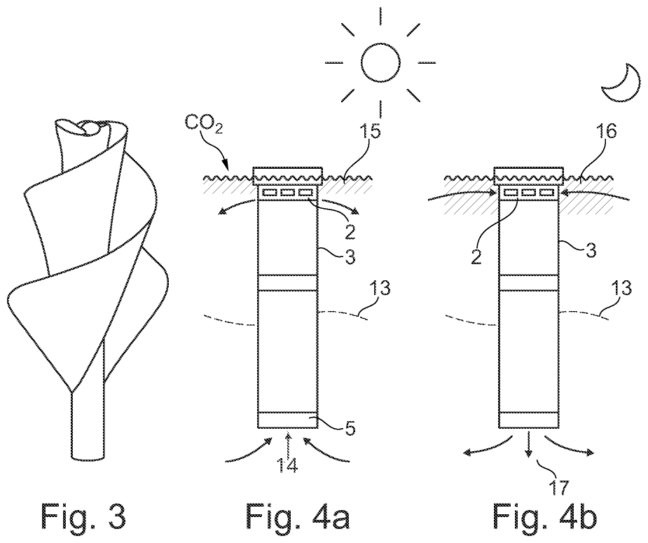

In the example shown in FIG. 2 a downwelling open channel circulation system is based on a series of vortex generating impellers mounted along the channel axis: Water is drawn into the upper technical module (7) by the impeller (11) which is designed to set the water into rapid rotation and push it downwards in an elongated vortex centered along the channel axis. During recent years, novel impeller designs have emerged enabling directed flows of water within large bodies of water, requiring modest energy expenditure. An example is the Lily impeller designed by J. Harman (https://www.treehugger.com/the-lily-impeller-nature-based-design-inspires-game-changing-efficiencies-4863361) which is illustrated in FIG. 3. The directed vortex flow from a single impeller has a finite range, and in order to achieve water transport across longer distances the system shown in FIG. 2 employs a plurality of impellers located in series forming a chain along the axis of the open channel circulation system. By proper positioning, most of the water exiting from one vortex is captured by the next impeller in the chain and transported further downwards instead of entering a backflow. As shown in FIG. 2, the final vortex in the chain enters the lower technical module (10) where a stream of water (12) is directed away from the open channel circulation system in a predetermined fashion by active or passive means that may include one or more impellers and/or guides.

Certain applications employing embodiments of open and closed circulation systems shall now be described:

### Diel Cycling and the Biological Pump.

It is estimated (cf, e.g.: Earth 103: Earth in the future “Ocean-Atmospheric Exchange” (https://www.e-education.psu.edu/earth103)) that 92-93 gigatons of atmospheric carbon is taken up by the oceans through the air/sea interface per year. At the same time approximately 90 gigatons of carbon are degassed from the oceans to the atmosphere each year, for a net flow of 2-3 gigatons of carbon into the oceans. This net flow accounts for 25-30% of the carbon that is added yearly to the atmosphere. The main driving force for carbon transport through the air/sea interface is diffusion due to the difference between CO₂ partial pressures in the air above and the water in the surface layer. CO₂ that enters the water is accommodated in part via an inorganic pathway where CO₂ is dissolved in the water and undergoes a series of reactions involving bicarbonates and carbonates, and in part via an organic pathway involving photosynthesis in phytoplankton (the “Organic Carbon Pump”). The direction and magnitude of the carbon transport varies between locations, reflecting sea surface temperatures, carbon sources and sinks, water circulation patterns, etc.

The present invention is based on the premise that it is possible to modify the uptake and degassing of CO₂ at the sea surface by inducing a closely controlled, diel based upwelling and downwelling of seawater. This is achieved by means of open and/or closed channel circulation systems according to the present invention. As noted above, the net flux of CO₂ into the oceans is the difference between two very large, but opposing fluxes. Thus, only a few percent reduction in the degassing from the oceans shall have dramatic effects on the net atmospheric CO₂ budget. In nature, phytoplankton in the euphotic zone consumes CO₂ and generates oxygen and biomass during the daytime, acting to promote CO₂ capture from the air through the air/water interface. During nighttime, the process is reversed, with biomass (phytoplankton, plant material, bacteria, zooplankton) in the mixing zone (the photic zone and adjacent layers above the thermocline) emitting CO₂ through respiration and decomposition of organic matter, thus elevating the partial CO₂ pressure in the water at the air/water interface and promoting degassing of CO₂ into the atmosphere.

The present invention teaches a direct intervention by inducing localized and time-controlled upwelling and downwelling, disrupting the natural diurnal process described above:
During the daylight hours, controlled upwelling brings cold, nutrient-rich water to the surface. This stimulates photosynthetic growth and at the same time cools the surface, increasing CO₂ solubility and CO₂ transport from the air into the water.
During the dark hours, controlled downwelling draws dissolved organic carbon (DOC) and particulate organic carbon (POC) in the mixing layer into the depths, for harvesting or sequestration. The downwelling simultaneously transports inorganic carbon away from the surface and causes oxygenated water to be transferred to deep regions where anaerobic conditions may prevail.

FIGS. 4a, 4b show an enclosed circulation system during daytime (FIG. 4a) and nighttime (FIG. 4b) conditions. The enclosed channel (3) extends below the thermocline (13).
During the daytime (FIG. 4a) the system is configured in an upwelling mode where cold, nutrient-rich water (14) is inducted through the lower technical module (5), transported upwards through the enclosed channel (3) and expelled into the photic zone (15) in the upper water layers. This stimulates primary production by photosynthetic organisms and promotes capture of inorganic carbon from both the water phase and the air above: Even under planktonic bloom conditions, it has been observed that dissolved CO₂, bicarbonates and carbonates in the upwelled water are consumed by the photosynthetic organisms at a rate which avoids build-up of dissolved CO₂ and diffusion into the air at the water/air interface (Cf., e.g.: J. Kanwisher: “pCO₂ in Sea Water and its Effect on the Movement of CO₂ in Nature”, Tellus, 12:2, 209-215, 1960). Furthermore, the cold, upwelled water lowers temperatures in the water surface, increasing the solubility of CO₂ and enhancing uptake of CO₂ from the atmosphere above. The cold water surface may have a significant cooling effect on the atmosphere above. As an example, a simple calorimetric estimate shows that thermal equilibration between a water layer at temperature T_{Water}=2° C. and of depth 2.5 m and an adjacent air layer at temperature T_{Air}=15° C. and height 1000 m results in a common temperature T_{Common}=3.2° C.

This suggests that cold water upwelling may affect the local climate: A system upwelling 100.000 m³/hr would fill a sea subsurface volume of 960.000 m² surface area by 2.5 m depth in 24 hours.
During the nighttime (FIG. 4b) the system is configured in a downwelling mode: Water is sucked into the system via the upper technical module (2), bringing with it live and dead biomass (16) and dissolved gases and inorganic material. An important component shall be oxygen produced by phytoplankton during the daylight hours which, when released at depth, can bring life to anoxic regions. In the example shown in FIG. 4b, the water is transported through the enclosed channel (3) and expelled at a deep location (17) for temporary or permanent sequestration. As an alternative to sequestration, biomass may be captured in traps inside the enclosed channel (cf. below) and provide raw material for animal feed, agriculture or industry.

The terms “daytime” and “nighttime” were used somewhat loosely above, to indicate correlation with photosynthetic activity. In practice the optimal upwelling and downwelling periods shall vary with latitude and seasons, and the systems shall typically incorporate sensors that record relevant parameters such as ambient light level, particulate load, water temperature, and CO₂ and O₂ concentrations in the water.

### Nanocavity Seeding of Upwelled and Downwelled Water.

Nanocavities in the form of gas filled bubbles with a diameter in the sub-micron domain possess unique properties of particular interest in the present context: Under certain circumstances they exhibit long term survival in water before dissolution or disruption, and they have neutral buoyancy, following the local water flow without floating to the surface (cf., e.g.: F. Eklund “Nanobubbles in water-how to identify them and why they are stable”, Chalmers Univ. of Technology 2019 (https://research.chalmers.se/publication/508872/file/508872 Fulltext.pdf)).

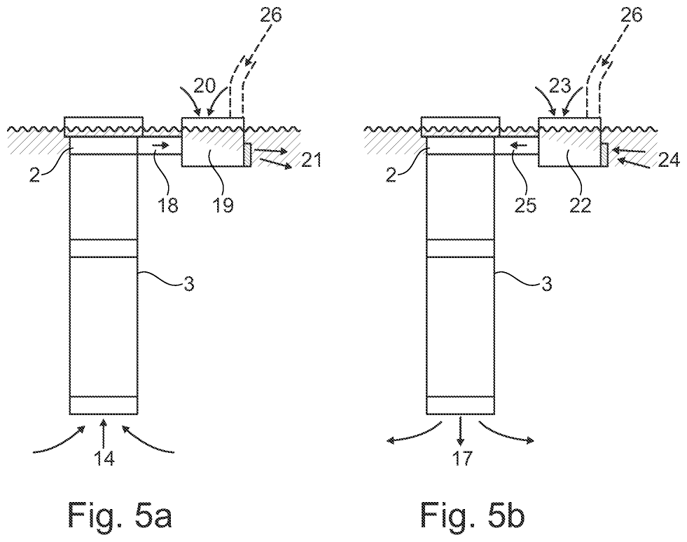

FIG. 4a showed a situation involving upwelling of cold water which was guided into the upper water layers surrounding the system. Since cold water is more dense than warmer water, there is a possibility that the purpose of upwelling in this case is defeated by the upwelled water sinking rapidly into the depths again. According to the present invention, this problem is solved as illustrated in FIG. 5a: Here, the cold water (14) pumped up from the deep is seeded with gas-filled nanocavities before being distributed near the water surface. This reduces the density of the cold water and makes it possible for the upwelled water to reside in the upper water levels for extended periods of time. In this example, the upper technical module (2) delivers the dense cold water via a tube (18) to a nanocavity generator (19) which draws air (20) from the atmosphere above, creating air-filled nanocavities. The nanocavity laden water is then distributed (21) in the upper water layers.

FIG. 4b showed a situation involving downwelling of water which was drawn in from the upper water layers (15) surrounding the system, causing dissolved and particulate material from this region to be transported to a deep location (17) in the sea. This downward water flux may be taken advantage of to serve as a transport path for materials that are admixed into the water entering the system at the top. Of particular interest in the present context is seeding with gas filled nanocavities, as illustrated in FIG. 5b: A nanocavity generator (22) draws in air (23) and water (24) and creates a nanocavity laden water stream which is fed via a tube (25) into the upper technical module (2) and transported through the system into the deep location (17). Here the air-filled nanocavities remain and disperse without floating up to the surface, transporting oxygen and rejuvenating and sustaining habitats that would otherwise be anoxic dead zones.

The configurations shown in FIGS. 5a,b are only examples to illustrate the principles involved. Thus, the nanocavity generators (19), (22) may be integrated into the upper technical module (2), and they may draw gas for the nanocavities from other sources (26) than the ambient air (20), (23). Also, the enclosed channel circulation systems (3) in FIGS. 5a,b may be supplanted by modified open channel circulation systems similar to that shown (8) in FIG. 2.

### CO₂ Capture and Downwelling.

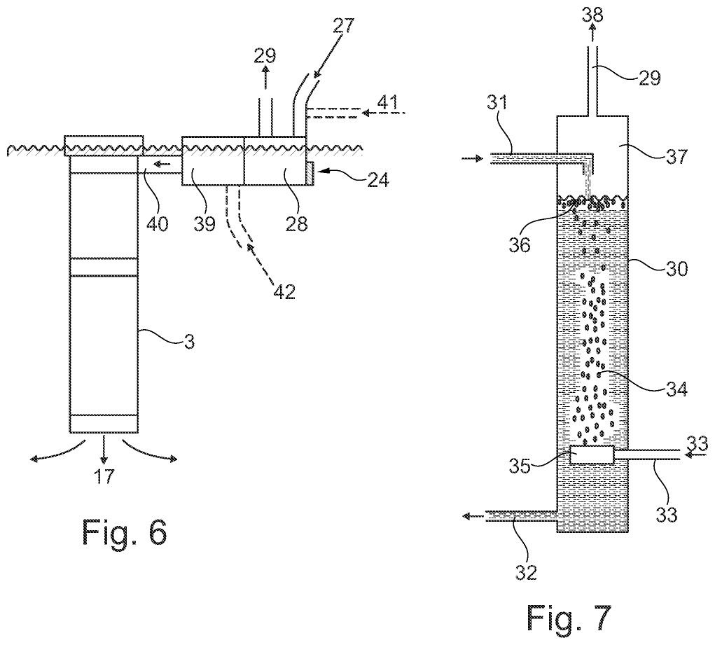

FIG. 6 shows an embodiment where CO₂ is delivered in the flue gas (27) from a point source, dissolved in water and ultimately transported into deep water layers. The flue gas carries CO₂ as a minority component along with other gases, typically in relative proportions of 20-80%, 2.5-4% and 1-25% for N₂, O₂ and CO₂, respectively. The total gas volumes from relevant point sources are huge (typically of the order of 100.000 m³/hr), and direct transport into deep water of buoyant gases, including CO₂, would be impractical and prohibitively costly. According to the present invention, the problem is solved by carrying out the following steps:
1) Water (24) and flue gas (27) enter a separation stage (28), where N₂ and O₂ are removed and ejected into the atmosphere (29) while the CO₂ and its dissolution products remain in the water. One example of a relevant separation principle is shown in FIG. 7, where the much higher solubility of CO₂ in water compared to N₂ and O₂ is exploited in a counterflow configuration: Water flows downwards through a column (30), entering through a tube (31) and exiting through a tube (32). Flue gas (33) is injected as bubbles (34) through a diffuser (35). As the bubbles rise in the column (30), the CO₂ dissolves in the water and the N₂ and O₂ remain trapped in the bubbles, which burst at the surface (36) and release their content into the void (37). The N₂ and O₂ is vented to the atmosphere (38) through the tube (29), while carbonic acid and carbonate laden water exits through the tube (32). It should be emphasized that this separation principle is described here by way of example only, and that other alternatives exist.
2) Referring to FIG. 6: Water from the separation stage (28) carrying dissolved inorganic carbon (DIC) (CO₂/carbonic acid/bicarbonate/carbonate) is treated in a process unit (39) where physical and chemical parameters (e.g.: temperature, alkalinity) are controlled and adjusted.
3) The DIC laden water is transferred into the circulation system (3) via the tube (40) and downwelled to a deep location (17).
4) It is technically straightforward to store DIC laden water in near neutrally buoyant storage receptacles, e.g. lightweight flexible bags, in the sea for temporary storage or later use.

The DIC laden water may be used directly or after nanocavity treatment as pore penetrating fluid in enhanced oil recovery operations. DIC laden water may be sequestered in the deep ocean below the thermocline, where it generally expected to reside for millennia due to the slow turnover of water in a stratified sea. Another solution is to expose minerals in the sea floor to the carbonate-laden water, which ensures that the carbon is locked in permanently. Yet another sequestration method is to fill the very large void volumes associated with abandoned subsea oil wells and aquifers.

The procedure described above ensures that energy consumption is kept at a minimum:
The bulk of the flue gases is removed at an early stage and at shallow water depths, avoiding expending significant compression energy.
The CO₂ is transferred from low density gas to dissolved inorganic carbon (DIC) laden water which maintains near neutral buoyancy in the water and can be transported to different depths and distant locations with small energy expenditure.

In certain cases, it is desirable to avoid high local concentrations of DIC resulting from releasing large volumes of concentrated DIC laden water into the sea. One strategy for solving this problem is to dilute the DIC laden water to acceptable concentration levels before releasing the effluent into the environment. It may be noted that average background levels of DIC in the world's oceans is estimated at 140 g/m³. This shall only increase to a very small degree (less than 2%) even if all remaining and usable fossil fuel resources were burnt and evenly admixed in the global oceans. In principle, the concentrated gas (27) may be diluted with fresh air (41) before entering the separation stage (28), but this would add very large gas volumes to the gas handling task. A better solution is to dilute the post separation stage DIC laden water with fresh water (42). This may take place either in the process unit (39) as shown in FIG. 6, or at some later stage in the circulation system leading to the effluent location (17).

As shall be evident to a person skilled in the art, the embodiments described above shall be applicable to other CO₂ sources in addition to point emitters. One example is Direct Air Capture (DAC), i.e. extracting and sequestering CO₂ from ambient air: Ordinary air contains 0.79 gCO₂/m³. Capturing 100.000 m3 of air per hour per system equals a CO₂ capture of 692 tons per year.

### Bioreactor

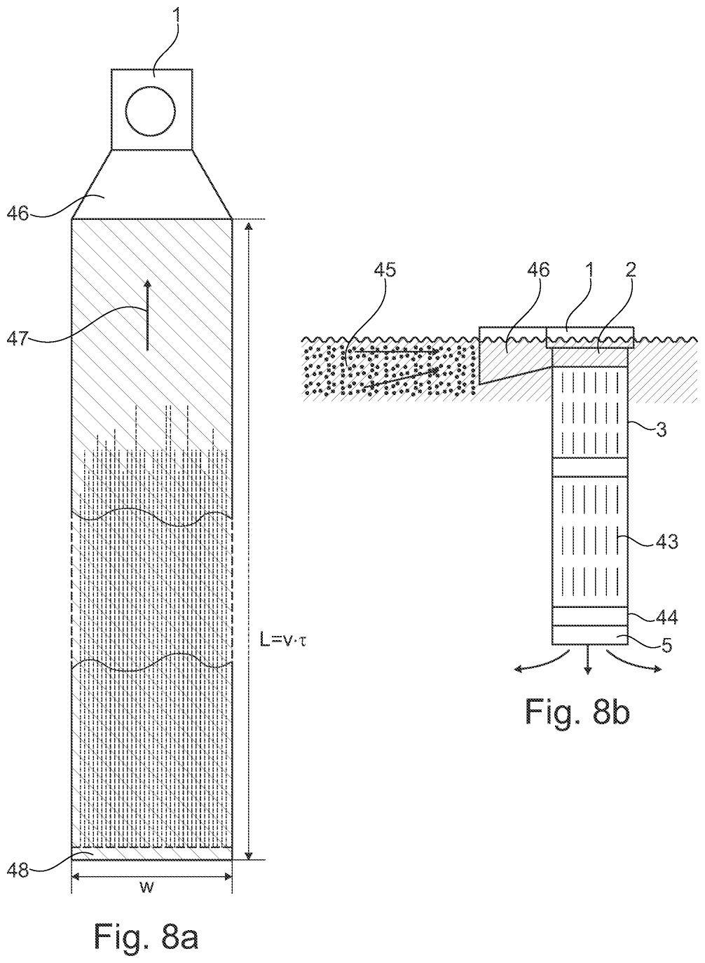

FIGS. 8a,b show a top view (FIG. 8a) and a side view (FIG. 8b) of a preferred embodiment where an enclosed channel circulation system is employed as a bioreactor. Water is drawn through the upper technical module (2) and is downwelled through the enclosed channel (3) before exiting from the lower technical module (5). In this example, the enclosed channel contains a network of substrates (43), indicated in FIG. 8b by stippled segments (43) in an x-ray view, that serve as habitats for attached filter animals in the form of tunicates, e.g. ciona intestinalis. The substrates may take many forms, among them a set of cables or ropes extending from the top to the bottom of the enclosed channel. Another variant is a set of vertically stretched canvas or plate surfaces arranged in a pattern that allows vertical flow of water between them. The tunicates live in the dark and filter algae and other particulates from the stream of water, expelling feces and pseudofeces in the form of sedimenting pellets that are collected by a particle trap (44) below. Both the tunicate biomass and their fecal production represent valuable materials for applications in medicine, animal feed and materials technologies. As shown in FIG. 8b, water is drawn from the upper water layers, bringing with it particulate nutrients (45) in the form of phyto- and zooplankton, bacteria, etc. In the embodiment shown, the system is positioned in a natural water flow (47) and an intake manifold (46) oriented towards the flow is used to enhance and control the collection process. If the average flow velocity is v, a manifold with cross sectional area wd shall capture a water volume V=wdv□ and sweep across a water surface area A=vw□ during a time period □. Assuming, e.g., the numerical values v=3 m/s, w=20 m, d=5 m, and ∞=1 hr, one finds:
V=1.08 10⁶ m³ and A=2.16 10⁵ m².

The system shown in FIGS. 8a,b provides an opportunity for resolving two fundamental problems in microalgae farming, namely i): The illumination bottleneck, and ii) Dewatering:
i) Due to the distributed nature of solar energy and finite light intensity tolerance in photosynthetic organisms, traditional algae farming must occupy large light exposure areas in the form of ponds, tubes or raceways in order to achieve acceptable production volumes, resulting in poor profitability. In the present example, the phytoplankton captured by the system has been exposed to light for long periods during its transport from remote locations upstream, effectively extending the illuminated farming area to large swathes of the free ocean surface (ref. the cross hatched area in FIG. 8a with □ ranging up to several days).
ii) Microalgal biomass is dilute in cultures (up to 0.3-0.5 g dry biomass/I), resulting in difficulties in harvesting and dewatering algae cost effectively. Thus, microalgae harvesting by traditional methods can typically make up to 20-30% of the total biomass production cost, making the harvesting process a major bottleneck and hindering the development of the microalgae industry. A tunicate based bioreactor as shown in FIGS. 8a,b solves this problem: Tunicates filter nutrient particulates in the water across an extraordinary range of sizes down to approximately 1 μm and expels feces and pseudofeces in the form of compact pellets that are easy to extract from the water flow in the particle trap (44). The latter may be, e.g., a sieve, a sediment device or a hydrocyclone.

The productivity of the farming system in FIGS. 8a,b lends itself well to being enhanced by fertilizing the phytoplankton in the photic zone near the sea surface, at one or more upstream locations suitably distanced from the system to allow the fertilizer to be effective. Thus, if fertilizer is spread on the water at the location (48) in FIG. 8a, a time □ will elapse before the phytoplankton reaches the intake manifold (46), allowing time for metabolism in the phytoplankton.

As shall be evident to a person skilled in the art, the generic enclosed channel circulation system may be specialized in many different operational modes to accommodate biomass production at various trophic levels, providing a high level of control over all relevant operational parameters, e.g.:
Continuous flow-through of up- or downwelled water to provide nutrients and fresh water to sessile or trapped biological species inside the reactor, as exemplified in FIGS. 8a,b;
Periodic exchange of water inside an enclosed volume inside the reactor. The system would in this case include means for closing the channel at one or both ends, and for containment of the farmed species, e.g. heterotrophic biomass (algae, bacteria, virus), crustaceans, fish, benthic organisms.
Parallel operation employing connected reactors or reactor segments, e.g. farming of different species that are fed to progressively higher trophic level organisms.

Although closed channel circulation systems generally provide more control over habitat parameters, open channel circulation systems can also serve as bioreactors. As shall be apparent to a person skilled in the art, biomass can be kept in place and be exposed to the water stream inside a open channel system in a variety of ways, either with the biomass directly attached to substrates in the form of ropes, canvas, or stiff plate- or band-like structures or contained within mesh bags, cages, etc. Examples of the former are cases involving sessile organisms such as tunicates, mussels, etc. In analogy with the case of closed channel circulation systems, particulates such as fecal materials can be collected by particle traps before the water exits from the system.

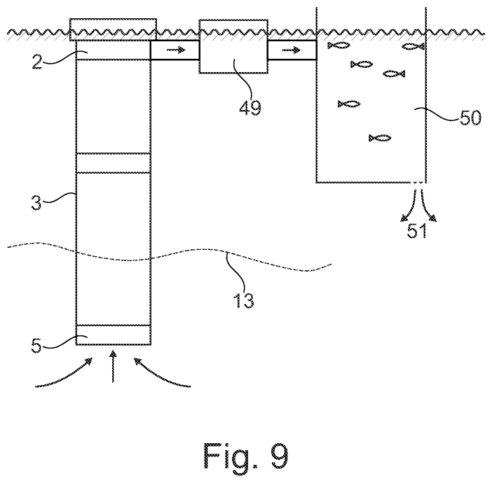

FIG. 9 shows a variant of an upwelling/bioreactor application which can make it possible to farm salmon and other cold water marine species even in warm water regions: Water is drawn into the system through the lower technical module (5) at a depth below the thermocline (13) where the water temperature is low, and upwelled through the channel (3). Cold water exits through the upper technical module (2) and enters a conditioning stage (49) before being transported into the enclosed volume (50), which in this example is an enclosed volume for farming of cold-water fish. Spent water (51) from the bioreactor is expelled to the surrounding water volume. The conditioning stage (43) may perform several tasks, e.g.: Controlling the oxygen content and salinity of the water, adding nutrients and medicines, and maintaining optimal water temperature by suitable admixture of warm surface water to the cold upwelled water.

1. A system for transport of water between different depths in a body of water, where the system comprises:
a sequence of modules constituting a channel with an upper and a lower channel end and a channel length, with at least one of the modules being a technical module arranged at the upper and/or lower channel ends, for allowing water to enter at least one channel end, being transported through the channel, and exiting at the other channel end, and
impeller means arranged related to the at least one technical module for contributing to the transport of water, and
controlling and guiding means arranged related to the at least one technical module for controlling and guiding flow of water into or out of the channel.

2. The system according to claim 1, where the system is arranged for controllable up- and/or downwelling, where up- and downwelling respectively correspond to effecting transport of upwelled water from the lower to the upper channel end, and of downwelled water from the upper to the lower channel end.

3. The system according to claim 1, where the channel is an enclosed channel comprising a wall arranged for confining water within a cross section of the channel limited by the wall.

4. The system according to claim 1, where the channel is an open channel where the impeller means are arranged for generating a flow of water within a cross section of the channel limited by dynamic forces.

5. The system according to claim 1, where part of the channel length is an enclosed channel comprising a wall arranged for confining water within a cross section of the channel limited by the wall, and part of the channel length is an open channel where the impeller means are arranged for generating a flow of water within a cross section of the channel limited by dynamic forces.

6. The system according to claim 1, comprising at least one impeller arranged related to the channel and located between the upper and lower channel ends.

7. The system according to claim 1, where the impeller means are arranged for controllably contributing to transport of water into the channel, and to pushing it through the channel.

8. The system according to claim 1, where the impeller means are arranged for controllably contributing to transport of water out of the channel, and pulling it through the channel.

9. The system according to claim 8, where the sequence of modules comprises at least one extension module arranged between the channel ends, where the at least one extension module comprises at least one of the following: i) impeller means arranged to contribute to the transport of water through the channel, ii) diagnostic equipment arranged for measuring characteristics of the water in the channel, and iii) length extension of the channel.

10. The system according to claim 1, where the impeller means comprises at least one motor driven impeller arranged to i) propel water inside the channel and/or ii) set up vortex motion.

11. The system according to claim 10, where the at least one motor driven impeller is of the Lily type.

12. The system according to claim 4, further comprising a suspension system arranged to connect at least two neighboring modules, and physically contribute to control relative position of the connected modules.

13. The system according to claim 1, comprising a topside platform comprising buoyancy elements, a work deck, operational equipment and suspension means for enclosed or open channels.

14. The system according to claim 1, comprising control means arranged for controlling direction of the water flow in the channel according to a predetermined time schedule or according to input data from system-associated sensors measuring physical or chemical environmental factors.

15. The system according to claim 14, where the physical or chemical environmental factors include one or more of the following: Ambient light level above or below water surface, concentration of dissolved CO₂ or O₂ at selected points in the water flow in the system, pH and temperature at selected points in the water flow in the system, turbidity.

16. The system according to claim 15, where the body of water has a photic zone and a thermocline, and where the channel is arranged with the upper channel end in the photic zone and the lower channel end below the thermocline, and the controlled direction of the water flow is from the photic zone to below the thermocline in a downwelling period of a 24-hour period, and from below the thermocline to the photic zone in an upwelling period of the 24-hour period.

17. The system according to claim 16, where the upwelling period takes place during hours of daylight (“daytime”) and the downwelling takes place during hours of darkness (“nighttime”).

18. The system according to claim 1, further comprising generator means arranged for generating gas-filled bubbles and/or nanocavities, and seeding means arranged for seeding water in the channel with the gas-filled bubbles and/or nanocavities.

19. The system according to claim 18, where the seeding means are arranged for seeding upwelled water and the system is arranged for distributing upwelled water into surface layers in the water surrounding the system or at remote locations, where the temperature of the upwelled water is lower than the temperature of the water where it is distributed.

20. The system according to claim 1, comprising means for introducing water carrying dissolved inorganic carbon (DIC laden water) into the channel for downwelling.

21. The system according to claim 20, where the means for introducing DIC laden water comprises a separator stage arranged for receiving flue gases and water, removing N₂ and O₂ from the flue gas and dissolving CO₂ in the water.

22. The system according to claim 21, further comprising means for processing arranged to control and adjust physical and chemical parameters of the DIC laden water.

23. The system according to claim 20, comprising means for sequestration of downwelled DIC laden water, by one or more of the following: Dispersion into deep sea water volumes, temporary storage in flexible containers in the sea, exposing seafloor minerals to react with DIC laden water, filling void volumes associated with abandoned subsea oil wells and aquifers, using DIC laden water as forcing fluid in EOR (Enhanced Oil Recovery).

24. The system according to claim 21, further comprising at least one of i) means for admixing air with the flue gas before being received by the separator stage, and ii) means for diluting the DIC laden water with fresh water.

25. The system according to claim 1, where the system is adapted to function as a bioreactor for farming of aquatic organisms, comprising:
containment and exposure means for containment of the aquatic organisms within the channel and for exposing them to water flowing through the channel.

26. The system according to claim 25, where the containment and exposure means comprise substrates with surfaces, adapted to serve as habitats for sessile organisms, the substrates being arranged in the channel and exposed to water flowing in the channel.

27. The system according to claim 26, where the substrates comprise at least one of the following: ropes, flexible sheets, plates, and bands.

28. The system according to claim 25, where the containment and exposure means are comprises at least one of the following: mesh bags and cages.

29. The system according to claim 25, where the aquatic organisms comprise at least one of the following: autotrophic or heterotrophic biomass, algae, tunicates, mussels, crustaceans, fish, and benthic organisms.

30. The system according to claim 25, further comprising particle trap means arranged for collecting particulate materials ejected by the aquatic organisms.

31. The system according to claim 25, further comprising means for controlling the flow of water through the bioreactor.

32. The system according to claim 25, further comprising an intake manifold arranged at one channel end and adapted to lead water in a natural water flow in the body of water into the channel.

33. The system according to claim 32, further comprising means for upstream seeding of the natural water flow in the body of water being led into the channel.

34. The system according to claim 1, where the system is adapted to function as a bioreactor, and where the system is arranged with the lower channel end at a depth below the thermocline (13) of the body of water for drawing water into and upwelling it through the channel, and where the system further comprises:
a conditioning stage (49) arranged for receiving and conditioning the upwelled water;
a farming volume (50) arranged for receiving the conditioned water and for farming of cold-water fish or other organisms; and
expelling means arranged to expel spent water (51) from the farming volume into the body of water.

35. The system according to claim 34, where the conditioning stage (49) is arranged for performing one or more of the following tasks:
controlling the oxygen content and salinity of the upwelled water,
adding nutrients and medicines to the upwelled water,
admixing surface water to the upwelled water for maintaining optimal water temperature, where the surface water is warmer than the upwelled water.

36. A method for transport of water between different depths in a body of water, where the method comprises:
controlling and guiding a flow of water from the body of water into and/or out of a channel constituted of a sequence of modules with at least one of the modules being a technical module arranged at the upper and/or lower channel ends; and
contributing to transporting water through the channel by impeller means arranged related to the at least one technical module.

37. The method according to claim 36, where the method comprises controllable up- and/or downwelling, where up- and downwelling respectively correspond to effecting transport of upwelled water from the lower to the upper channel end, and of downwelled water from the upper to the lower channel end.

38. The method according to claim 36, where the method comprises:
controlling direction of the water flow in the channel according to a predetermined time schedule or based on input data from system-associated sensors measuring physical or chemical environmental factors.

39. The method according to claim 36, where the body of water has a photic zone and a thermocline, and where the method comprises:
arranging the channel with the upper channel end in the photic zone and the lower channel end below the thermocline; and
controlling direction of the water flow from the photic zone to below the thermocline in a downwelling period of a 24-hour period, and from below the thermocline to the photic zone in an upwelling period of the 24-hour period.

40. The method according to claim 39, where the upwelling period takes place during hours of daylight (“daytime”) and the downwelling takes place during hours of darkness (“nighttime”).

41. The method according to claim 36, comprising:
generating gas-filled bubbles and/or nanocavities; and
seeding water in the channel with the gas-filled bubbles and/or nanocavities.

42. The method according to claim 41, comprising the following steps:
upwelling water;
seeding the upwelled water with gas-filled bubbles and/or nanocavities; and
distributing the upwelled water into surface layers in the water surrounding the system or at remote locations where the temperature of the upwelled water is lower than the temperature of the water where it is distributed.

43. The method according to claim 41, where the gas in the gas-filled bubbles and/or cavities include one or more of the following: Ambient air, CO₂, O₂, flue gas, and the seeding comprises seeding water from surface layers, and the method further comprises:
downwelling the seeded water.

44. The method according to claim 43, comprising:
at least partially removing other gases than CO₂ before generating the bubbles and/or nanocavities.

45. The method according to claim 36, further comprising admixing materials into water in the channel.

46. The method according to claim 41, comprising:
controlling and adjusting physical and chemical parameters of the seeded water before entering the channel; and
downwelling the seeded water.

47. The method according to claim 36, comprising:
introducing water carrying dissolved inorganic carbon (DIC laden water) into the channel; and
downwelling the DIC laden water.

48. The method according to claim 47, where the introducing DIC laden water comprises receiving flue gases and water, removing N₂ and O₂ from the flue gas and dissolving CO₂ in the water in a separator stage.

49. The method according to claim 48, further comprising:
prior to the introducing DIC laden water, controlling and adjusting physical and chemical parameters of the DIC laden water.

50. The method according to claim 47, comprising:
sequestrating the downwelled DIC laden water by one or more of the following:
dispersion into deep sea water volumes, temporary storage in flexible containers in the sea, exposing seafloor minerals to react with DIC laden water, filling void volumes associated with abandoned subsea oil wells and aquifers, using DIC laden water as forcing fluid in EOR (enhanced oil recovery).

51. The method according to claim 48, further comprising at least one of i) admixing air with the flue gas before being received by the separator stage, and ii) diluting the DIC laden water with fresh water.

52. The method according to claim 36, where the method is used related to farming of aquatic organisms in a bioreactor, where the method further comprises:
containing the aquatic organisms within the channel; and
exposing the aquatic organisms to water flowing through the channel.

53. The method according to claim 52, further comprising at least one of the following steps:
collecting particulate materials ejected by the aquatic organisms by particle trap means;
leading water in a natural water flow in the body of water into the channel via an intake manifold arranged at one channel end; and
seeding of the natural water flow in the body of water being led into the channel.

54. The method according to claim 52, comprising:
upwelling water through the channel (3) from a depth below the thermocline (13);
conditioning the upwelled water in a conditioning stage (49);
transporting the conditioned water into an enclosed volume of the bioreactor (50) for farming of cold-water fish or other organisms; and
expelling spent water (51) from the enclosed volume to the surrounding water volume.

55. The method according to claim 54, where the conditioning comprises one of more of the following steps:
controlling oxygen content and salinity of the (upwelled) water;
adding nutrients and medicines to the (upwelled) water; and
admixing surface water to the upwelled water for maintaining optimal water temperature, where the surface water is warmer than the upwelled water.
